(19) United States
(12) Patent Application Publication
(10) Pub. No.: US 2021/0016537 A1
(43) Pub. Date: Jan. 21, 2021

(54) A TRUNK FLOOR FOR A MOTOR VEHICLE

(71) Applicant: Jean-Marie NAEGELE, Taicang City, Suzhou, Jiangsu (CN)

(72) Inventor: Jean-Marie NAEGELE, Taicang City, Suzhou, Jiangsu (CN)

(21) Appl. No.: 16/628,878

(22) PCT Filed: Nov. 7, 2018
(86) PCT No.: PCT/CN2018/114255

§ 371 Date: Jan. 6, 2020

(30) Foreign Application Priority Data
Oct. 30, 2018 (CN) 201811275991.9

(51) Int. Cl. B32B 3/12; B32B 5/18; B32B 5/24; B32B 5/32; B32B 15/20; B32B 15/04; B32B 29/00

(52) U.S. Cl. CPC B32B 3/12; B32B 5/18; B32B 5/245; B60R 13/011; B32B 15/20; B32B 15/046; B32B 29/007; B32B 5/32

(57) ABSTRACT

A trunk floor for a motor vehicle having a rigid carrier and a wear-resistant soft elastic protective layer. The rigid carrier is completely or partially protected by a wear-resistant soft elastic layer on its visible surface or side, and is wrapped by its shape. The structure can be used for a load floor or a parcel shelf or a rear seat back plate of a motor vehicle. The wear-resistant soft elastic protective layer is completely or partially covered on the visible surface or side of the rigid carrier, which effectively improves its wear resistance, tensile strength and elongation at break corresponding to the properties required from TPO in the commercial vehicle field, and has a certain acoustic effect at the same time.

### TECHNOLOGY FIELD

The invention relates to the technical field of automobile decorative materials, in particular to a trunk floor or a luggage carrier and a rear seat back plate for a motor vehicle.

### BACKGROUND TECHNOLOGY

In recent years, the design and performance of the vehicle trunk floor has changed a lot. In the past, when the spare tire was covered with a pressed cardboard or a plywood plate of relatively low strength and rigidity, the structure would change greatly if the support of the spare tire was lacking. For example, laminated wood plates and plastic structural panels are used. Composite material parts are put into use with the growing demand for weight reduction of components. These components are constructed in the form of a sandwich. The inner core is made of honeycomb paper, polypropylene or aluminum. The load-bearing layer with a thickness of 0.4 mm to 0.7 mm is made of nearly 100% polyurethane impregnated glass mesh and covers the inner paper core. These parts (glass fiber and rigid polyurethane foam double layer containing paper core) have an areal density of about 2-5 kg/m2, which is 80% lighter than conventional laminated parts. Known carbon fibers and natural fibers, especially bamboo, are also one of the solutions for reinforcement. Polypropylene containing glass fiber can be used in place of polyurethane and is suitable for various applications.

Whatever material and structure is used, the surface of the carrier material is hard, smooth but not slip-resistant. In most cases, they also have no visible outer surface. Because almost all structures are covered with additional surface materials. In the simplest case, it is a textile mat made of thinner or velvet carpet, most with low areal density, insulated or uninsulated. For sandwich structural components, the carpet must be securely attached to the carrier by post-bonding. These structures are used in a lot passenger cars.

For other vehicle models, such as station wagons, SUVs, vans, minivans, light trucks, plastic surfaces are also used. These surfaces are more durable and easier to clean, which is important for many applications.

In most cases, as a carpet friction mat, a TPO (thermoplastic polyolefin elastomer) material based on polypropylene or polyethylene is in a dominant position, another solution is a TPO material that is attached to a plastic-filled acoustic coating. Trucks and light trucks also use polyurethane injection mats made with the RIM process. The disadvantage of these solutions is, on the one hand, the high cost of component production. On the other hand, the mat may slip and cause partial damage to the mat when loading, unloading and driving. The firm connection of the plastic material to the carrier has not been determined in the application of the trunk floor, and the lamination of the plastic surface after conventional manufacturing will again significantly increase the manufacturing cost.

### Invention Content

In order to solve the above problems, the present invention proposes a trunk floor or a luggage carrier or a rear seat back plate for a motor vehicle, which has high strength, good wear resistance, and has mechanical properties such as tensile strength and elongation at break corresponding to the properties required from TPO in the commercial vehicle field.

The present invention is achieved by the following technical solutions:

A trunk floor for a motor vehicle, which is composed of a rigid carrier and a wear-resistant soft elastic protective layer. The rigid carrier is completely or partially protected by a wear-resistant soft elastic layer on its visible surface or side, and is wrapped by its shape.

Preferably, the rigid carrier is composed of honeycomb paper core, glass fibers and rigid polyurethane foam.

Preferably, the rigid carrier is composed of honeycomb aluminum core, glass fibers and rigid polyurethane foam.

Preferably, the rigid carrier is composed of honeycomb paper core, glass fiber, Carbon fiber or Kevlar fiber and rigid polyurethane foam.

Preferably, the rigid carrier is composed of honeycomb paper core, natural fiber and rigid polyurethane foam.

Preferably, the rigid carrier is composed of honeycomb aluminum core, glass fiber, Carbon fiber or Kevlar fiber and rigid polyurethane foam.

Preferably, the wear-resistant soft elastic protective layer is unfilled rigid polyurethane foam material.

Preferably, the building material of the wear-resistant soft elastic protective layer is rigid polyurethane foam material filled with inorganic particles.

Preferably, the wear-resistant soft elastic protective layer has a defined design.

The invention has the beneficial effects that the proposed structure of the invention can be used for the trunk floor or the luggage carrier or the rear seat back plate of a motor vehicle, by completely or partially covering the wearable soft elastic protective layer on the visible side or side of the rigid carrier. It can effectively improve its wear resistance, and the mechanical properties such as tensile strength and elongation at break corresponding to the properties required from TPO in the commercial vehicle field, and have an acoustic effect.

### DRAWING DESCRIPTION

FIG. 1 is a structure schematic view of Embodiment 1;

FIG. 2 is a cross-sectional view of the B-B side of FIG. 1;

FIG. 3 is a structure schematic view of Embodiment 2;

FIG. 4 is a cross-sectional view of the B-B side of FIG. 3:

FIG. 5 is a structure schematic view of rigid carrier.

Among them: 1, trunk bottom plate, 2, wear-resistant soft elastic protective layer, 3, rigid carrier, 4, honeycomb paper core, 5, fiberglass mat, 6, rigid polyurethane foam layer, 8, carpet.

### DETAILED MODE OF EXECUTION

The invention will now be further described with reference to the drawings and embodiments.

A trunk floor for a motor vehicle is composed of a rigid carrier and a wear-resistant soft elastic protective layer on the visible side and the side, the rigid carrier is bonded by a wear-resistant soft elastic protective layer completely or partially on its visible side and side, and is wrapped by its shape. Slightly difference is that the visible surface of the rotatable component can also be particularly made with other decorations, such as textile mat. As a rigid carrier for the related expected application, almost all rigid materials and structures can be used, whether the component is for covering or supportless. The sandwich structure of the preferred rigid carrier has a good stiffness-to-weight ratio. On the other hand, the construction material of the wear-resistant soft elastic protective layer must satisfy many conditions. Thus the selection of the construction material is relatively limited. The viscosity of the build material during the injection period must be low so that the entire part is completely closed on the visible surface and edge areas. The choice of higher viscosities, such as in thermoplastic injection molding period, it requires stronger and more expensive tools. In addition, multiple injection points are required in order to achieve a completely enclosed component coating. This can lead to surface defects. In addition, the high pressure generated may damage the sandwich component itself In the injection molding status, the plastic must have good mechanical properties such as high strength and high wear resistance. All of these properties can be achieved with a grid plastic system. The material of the rigid polyurethane foam floor mat which is made by the RIM process for free covering rather than being firmly attached to the carrier is the inevitable choice for this application. The material is solvent-free and therefore has a very low emission value, which reduces the vibration when it is fixedly connected to the rigid carrier and has a sound-absorbing effect. The building material itself is non-slip and can be further improved by appropriate surface design. In special material variants, the build material can have very soft elasticity and use the coating as a non-slip coating without the need for an extra non-slip mat. The material also has some UV resistance. If necessary, the UV resistance can be improved by additives.

In the present technical solution, the structure can also be applied to a parcel shelf or a rear seat back plate of a motor vehicle.

In the present technical solution, the defined design means that the surface of the wear-resistant soft elastic protective layer may be a smooth flat structure or a derma structure or a special surface texture or structure as required.

### Embodiment 1

A car from a US company uses the load floor of the above structure.

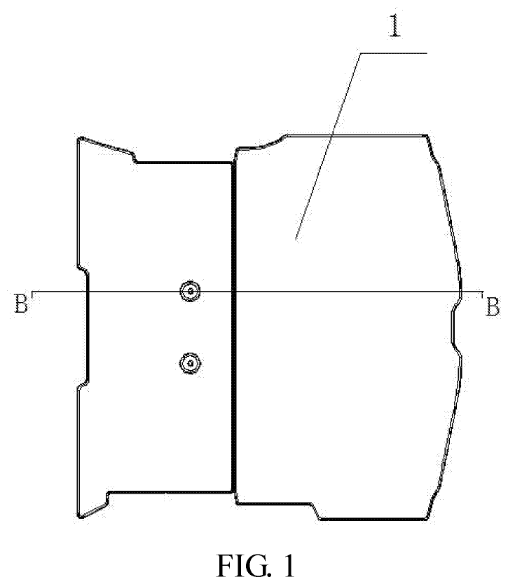

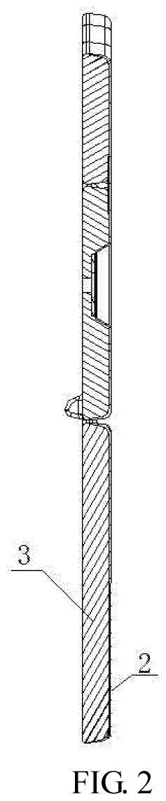

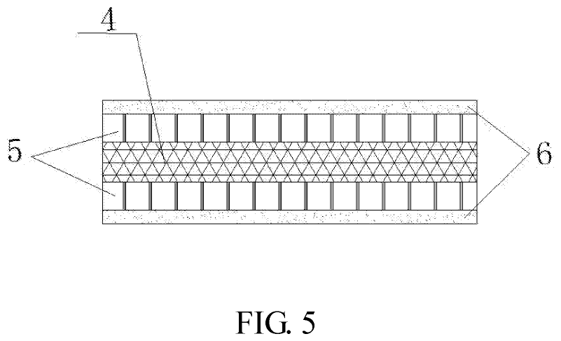

As shown in FIGS. 1, 2 and 5, a load floor for a motor vehicle is composed of a rigid carrier 2 and a wear-resistant soft elastic protective layer 1, on the visible side and the side, the rigid carrier 2 is partially bonded by a wear-resistant soft elastic protective layer 1 and encapsulated in an outer shape. The rigid carrier 2 uses a sandwich structure consisting of a 17 mm thick honeycomb paper core 3 and a 6 mm size socket hole. Opening it, the inside was dried and covered with a glass fiber mat 4 of 450 g/m2 on both sides. The rigid polyurethane foam layer 5 is formed by spraying with about 500 g/m2 of polyurethane rigid foam (for example, using a product of BASF Corporation) and then pressing at a temperature of about 120° C. to crosslink the polyurethane. After deburring, the unfilled polyurethane is then sprayed on the back and sides by the RIM process to form a wear resistant soft elastic protective layer 1. The viscosity of the material component is about 500 mPa·s in the polyol portion processing temperature, and the viscosity of the different portion is about 85 mPa·s. The wear-resistant soft elastic protective layer 1 has a thickness of 0.5 to 1.5 mm, depending on the area. The materials used are scratch resistant and have good abrasion resistance. Mechanical properties such as tensile strength and elongation at break may correspond to the eigenvalues required by TPO in the commercial vehicle field.

In the present embodiment, the honeycomb paper core 3 can be replaced by a honeycomb aluminum core or polypropylene; the glass fiber mat may also be replaced by one or more of natural fibers (bamboo fibers), carbon fibers or Kevlar fibers.

### Embodiment 2

A car from a US company uses the load floor of the above structure.

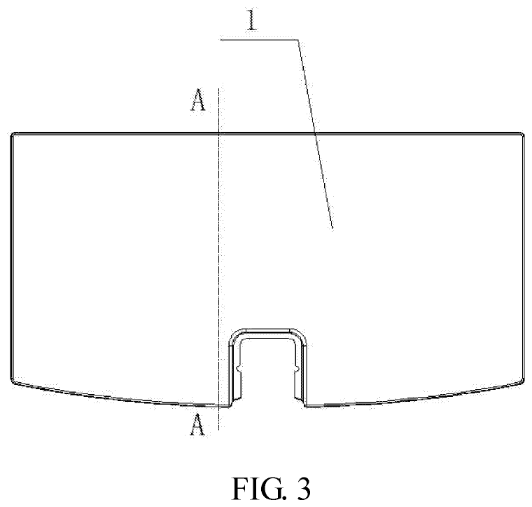

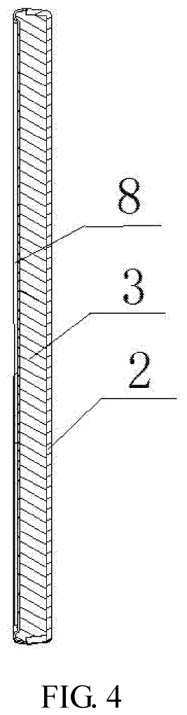

As shown in FIGS. 3, 4 and 5, a load floor for a motor vehicle is composed of a rigid carrier 2 and a wear-resistant soft elastic protective layer 1, on the visible side and the side, the rigid carrier 2 is partially bonded by a wear-resistant soft elastic protective layer 1 and encapsulated in an outer shape. The rigid carrier 2 uses a sandwich structure consisting of a 17 mm thick honeycomb paper core 3 and a 6 mm size socket hole. Opening it, the inside was dried and covered with a glass fiber mat 4 of 450 g/m2 on both sides. The rigid polyurethane foam layer 5 is formed by spraying with about 500 g/m2 of polyurethane rigid foam (for example, using a product of BASF Corporation) and then pressing at a temperature of about 120° C. to crosslink the polyurethane. After deburring, the unfilled polyurethane is then sprayed on the back and sides by the RIM process to form a wear resistant soft elastic protective layer 1. The viscosity of the material component is about 500 mPa·s in the polyol portion processing temperature, and the viscosity of the different portion is about 85 mPa·s. The wear-resistant soft elastic protective layer 1 has a thickness of 0.5 to 1.5 mm, depending on the area. The materials used are scratch resistant and have good abrasion resistance. Mechanical properties such as tensile strength and elongation at break may correspond to the eigenvalues required by TPO in the commercial vehicle field.

A fabric mat is then attached to the visible surface and a handle is mounted.

In the present embodiment, the honeycomb paper core 3 can be replaced by a honeycomb aluminum core or polypropylene; the glass fiber mat may also be replaced by one or more of natural fibers (bamboo fibers), carbon fibers or Kevlar fibers.

The above description is only the preferred embodiment of the present invention, and is not intended to limit the present invention, and for technicians in this field, various modifications and changes can be made to the present invention. Any modifications, equivalent substitutions, improvements, etc. made within the spirit and scope of the present invention are intended to be included within the protective scope of the present invention.

1. A trunk floor for a motor vehicle consisting of a rigid carrier and a wear-resistant soft elastic protective layer, wherein the rigid carrier is completely or partially protected by a wear-resistant soft elastic layer on its visible side or side and is wrapped by its shape.

2. The trunk floor for a motor vehicle according to claim 1, wherein the rigid carrier is composed of honeycomb paper core, glass fiber and rigid polyurethane foam.

3. The trunk floor for a motor vehicle according to claim 1, wherein the rigid carrier is composed of honeycomb aluminum core, glass fiber and rigid polyurethane foam.

4. The trunk floor for a motor vehicle according to claim 1, wherein the rigid carrier is composed of honeycomb paper core, glass fiber, Carbon fiber or Kevlar fiber and rigid polyurethane foam.

5. The trunk floor for a motor vehicle according to claim 1, wherein the rigid carrier is composed of honeycomb paper core, natural fiber and rigid polyurethane foam.

6. The trunk floor for a motor vehicle according to claim 1, wherein the rigid carrier is composed of honeycomb aluminum core, glass fiber, Carbon fiber or Kevlar fiber and rigid polyurethane foam.

7. The trunk floor for a motor vehicle according to claim 1, wherein the wear-resistant soft elastic protective layer is unfilled rigid polyurethane foam material.

8. The trunk floor for a motor vehicle according to claim 1, wherein the building material of the wear-resistant soft elastic protective layer is rigid polyurethane foam material filled with inorganic particles.

9. The trunk floor for a motor vehicle according to claim 1, wherein the wear-resistant soft elastic protective layer has a defined design.
